(19) United States
(12) Patent Application Publication
(10) Pub. No.: US 2012/0002501 A1
(43) Pub. Date: Jan. 5, 2012

(54) MIXING SYSTEM FOR MIXING A POWDERED BEVERAGE WITH A LIQUID

(75) Inventors: David Carl Ulstad, Dublin, OH (US); Wilson George Zeitler, Westerville, OH (US); Jacob Childs, Somerville, MA (US); Gaurav Rohatgi, Waltham, MA (US); Alan Lee Cameron, Natick, MA (US)

(73) Assignee: ABBOTT LABORATORIES, Abbott Park, IL (US)

(21) Appl. No.: 12/981,158

(22) Filed: Dec. 29, 2010

Related U.S. Application Data
(60) Provisional application No. 61/291,632, filed on Dec. 31, 2009.

(51) Int. Cl. B01F 7/00

(52) U.S. Cl. 366/205; 366/206

(57) ABSTRACT

In a mixing system for mixing together a powdered beverage and a liquid in-situ to form a ready-to-drink beverage, a receptacle has an interior space defining a mixing chamber for receiving powdered beverage and liquid therein to be mixed. An agitator is removably disposed in the mixing chamber, the agitator being operable to mix the powdered beverage and liquid within the mixing chamber, said agitator being removable from the receptacle. A retention member is configured to inhibit the agitator against falling out of the receptacle upon substantially inverting the receptacle. A drive system is provided for operating the agitator, with the agitator and drive system being configured for operative coupling therebetween. The mixing system may include a support for supporting the receptacle in an upright orientation. The receptacle may be removable from the support. The agitator may include an anti-vortex member to inhibit formation of a vortex.

### CROSS-REFERENCE

This application is a U.S. non-provisional application of U.S. provisional application Ser. No. 61/291,632 filed Dec. 31, 2009, the entirety of which is incorporated herein by reference.

### BACKGROUND

The field of the invention relates generally to mixing systems for mixing a powdered beverage with a liquid, and in particular to a magnetic mixing system.

Powdered infant/toddler formulas, energy drinks, soft drinks and other powdered beverages are typically mixed with a liquid (e.g., water or milk) to produce a consumable beverage in liquid form. To prepare the end product, the powdered beverage is scooped from its packaging, such as by a scoop provided with the packaging or by a suitable measuring spoon or cup, and loaded into a suitable receptacle. The liquid to be mixed with the powdered beverage may be provided in the receptacle prior to the powdered beverage being loaded therein, or the liquid may be added to the receptacle after the powdered beverage. The mixture is then stirred manually using a utensil, or the entire receptacle shaken, to mix the powdered beverage with the liquid to form the end product.

While stirring with a utensil or shaking the receptacle is a quick and easy means of mixing the powdered beverage, these methods may produce undesirable results. For example, if the mixture is not stirred or shaken sufficiently, the liquid beverage may not become a homogenous mixture, and the beverage may even contain powdered clumps. A homogenous beverage mixture is particularly desirably in nutritional beverage mixtures, such as infant formula, because ingestion of a homogenous beverage mixture facilitates absorption of the nutrients in the digestive tract. Moreover, mixing by shaking the receptacle typically produces a significant accumulation of air bubbles. As is generally known, these air bubbles are particularly undesirable in infant formula where ingestion of the bubbles by an infant may cause discomfort and a bloated stomach.

### SUMMARY

In one aspect, a mixing system for mixing together a powdered beverage and a liquid in-situ to form a ready-to-drink beverage generally comprises a receptacle having an interior space defining a mixing chamber for receiving powdered beverage and liquid therein to be mixed. An agitator is removably disposed in the mixing chamber, the agitator being operable to mix the powdered beverage and liquid within the mixing chamber, said agitator being removable from the receptacle. A retention member is configured to inhibit the agitator against falling out of the receptacle upon substantially inverting the receptacle. The retention member is further configured to allow operation of the agitator to mix the powdered beverage and liquid within the mixing chamber. A drive system is provided for operating the agitator, with the agitator and drive system being configured for operative coupling therebetween.

In another aspect, a mixing system for mixing together a powdered beverage and a liquid in-situ to form a ready-to-drink beverage generally comprises a receptacle having an interior space defining a mixing chamber for receiving powdered beverage and liquid therein to be mixed. An agitator is removably disposed in the mixing chamber and is operable for rotation about a rotation axis of the agitator in a generally horizontal plane to mix the powdered beverage and liquid within the mixing chamber. The agitator includes an anti-vortex member extending generally vertically relative to said horizontal plane, with the anti-vortex member being rotatable conjointly with the agitating member to inhibit the formation of a vortex about the rotation axis of the agitator. A drive system is included for operating the agitator, with the agitator and drive system being configured for operative coupling therebetween.

In another aspect, an appliance for mixing together a powdered beverage and a liquid to form a ready-to-drink beverage generally comprises a receptacle having an interior space defining a mixing chamber for receiving powdered beverage and liquid therein to be mixed. A support is included for supporting the receptacle at least in part in an upright orientation, with the receptacle being removable from the support. An agitator is removably disposed in the mixing chamber, and is operable to mix the powdered beverage and liquid within the mixing chamber. The agitator is removable from the receptacle. A drive system for operating the agitator is also included, with the agitator and drive system being configured for operative coupling therebetween.

### BRIEF DESCRIPTION OF THE DRAWINGS

FIG. 1 is a perspective of a first embodiment of a mixing system;

FIG. 2 is a right side elevation of the mixing system;

FIG. 3 is a top plan view of the mixing system;

FIG. 4 is a cross-section taken in a plane defined by line 4-4 in FIG. 3;

FIG. 5 is similar to FIG. 2 with a portion of a receptacle broken away to reveal an agitator disposed in a mixing chamber of the receptacle and with a drive system illustrated schematically;

FIG. 6 is a perspective of the agitator removed from the receptacle;

FIG. 7 is a right side elevation of the agitator of FIG. 6;

FIG. 8 is a left side elevation thereof;

FIG. 9 is a top plan view thereof;

FIG. 10 is a front elevation thereof;

FIG. 11 is a bottom plan view thereof;

FIG. 12 is a perspective of one embodiment of a beverage dispensing appliance incorporating a mixing system;

FIG. 13 is a perspective of another embodiment of a beverage dispensing appliance incorporating a mixing system;

FIG. 14 is a sectional view of a lower portion of a receptacle on a platform of a second embodiment of a mixing system;

FIG. 15 is a top plan view of an agitator of the mixing system of FIG. 14;

FIG. 16 is a sectional view of a lower portion of a receptacle on a platform of a third embodiment of a mixing system;

FIG. 17 is a top plan view of an agitator for use with the third embodiment of FIG. 16;

FIG. 18 is a sectional view of a lower portion of a receptacle of a fourth embodiment of a mixing system;

FIG. 19 is a perspective of an agitator of the mixing system of FIG. 18;

FIG. 20 is a sectional view of a lower portion of a receptacle on a platform of a fifth embodiment of a mixing system;

FIG. 21 is a perspective of an agitator for use with this fifth embodiment;

FIG. 22 is a sectional view of a lower portion of a receptacle of a sixth embodiment of a mixing system;

FIG. 23 is a perspective of an agitator for use with this sixth embodiment;

FIG. 24 is a sectional view of a lower portion of a receptacle of a seventh embodiment of a mixing system;

FIG. 25 is a top plan view of an agitator for use with this seventh embodiment;

FIG. 26 includes a sectional view of a lower portion of a receptacle of an eighth embodiment of a mixing system;

FIG. 27 is a top plan view of an agitator for use with this eighth embodiment;

FIG. 28 is a perspective of a ninth embodiment of a mixing system;

FIGS. 29 and 30 are schematics of a tenth embodiment of a mixing system; and

FIG. 31 is a side elevation of an eleventh embodiment of a mixing system.

### DETAILED DESCRIPTION OF THE DRAWINGS

In general, the present disclosure is directed toward a mixing system for mixing together a powdered beverage with a mixing liquid to form a ready-to-drink beverage. The powdered beverage may, in one embodiment, comprise a powdered nutritional beverage, such as powdered infant formula, powdered toddler or follow-on formula, powdered adult nutritional formula, powdered nutritional sports drinks, powdered protein or other energy drinks, or other nutritional beverages available in a powdered form. In other embodiments the powdered beverage may be a non-nutritive beverage such as a flavored soft drink or other powdered beverage that is typically mixed with a mixing liquid (e.g., water, milk, fruit juice, etc.) to prepare a ready-to-drink beverage. As used herein, the term powdered beverage means a beverage substance that is in the form of particulates, which may be fine or granular or any combination thereof. The powdered beverage is suitably of the type commonly used as a premix that is mixed with a liquid to form an end-product beverage.

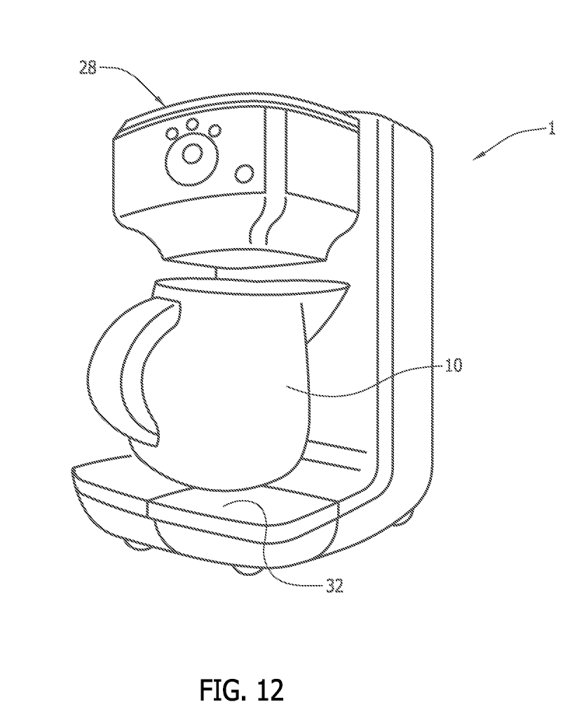

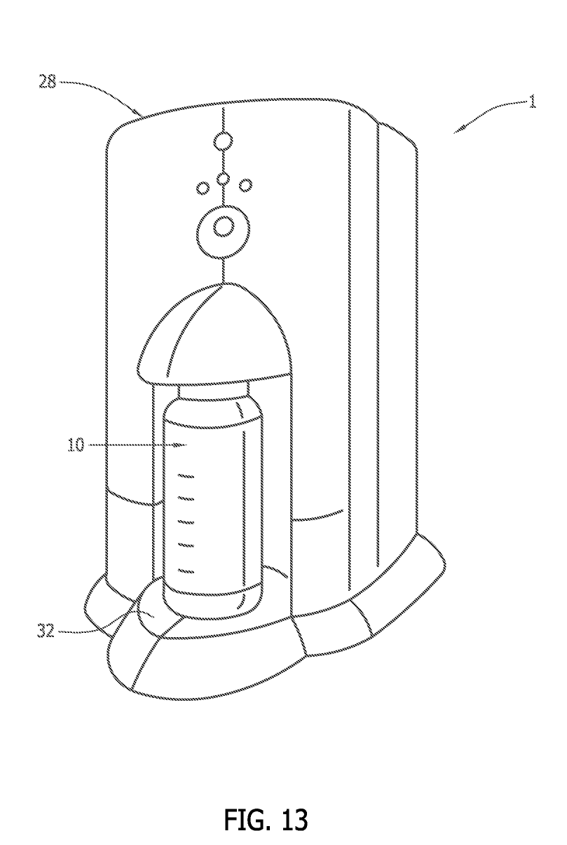

With particular reference to FIGS. 12 and 13, the mixing system according to one suitable embodiment is illustrated and described herein with reference to the use of such a mixing system with a powdered beverage dispensing appliance, which is generally indicated at 28. The appliance 28 includes a platform 32 on which a suitable receptacle 10 is placed for receiving powdered beverage dispensed by the appliance. More particularly, the powdered beverage dispensing appliance illustrated in FIGS. 12 and 13 is an infant formula dispensing appliance in which powdered infant formula and water are dispensed into a suitable receptacle such as a pitcher (FIG. 12) or nursing bottle (FIG. 13). The mixing systems set forth in the various embodiments herein are operable to mix the contents of the receptacle while the receptacle remains on the platform 32 of the appliance 28. It is understood, however, that the mixing systems described herein may be separate from the appliance, whereby the receptacle is removed from the appliance and co-located with the mixing system remote from the appliance. It is also understood the mixing systems disclosed herein may be used other than with a dispensing appliance, such as where the contents to be mixed are manually loaded into the receptacle, or otherwise loaded into the receptacle other than by a dispensing appliance, without departing from the scope of this invention.

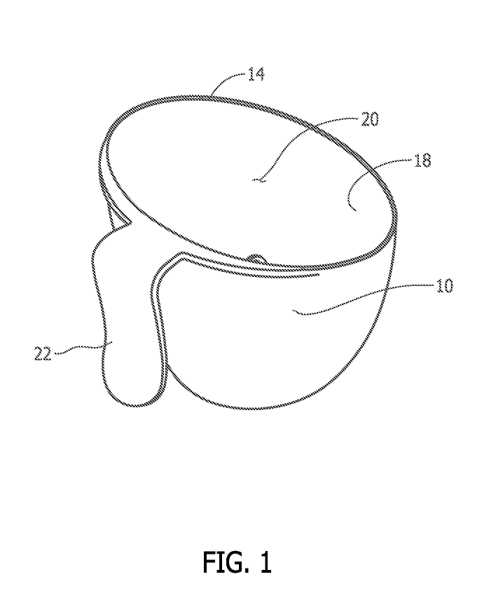

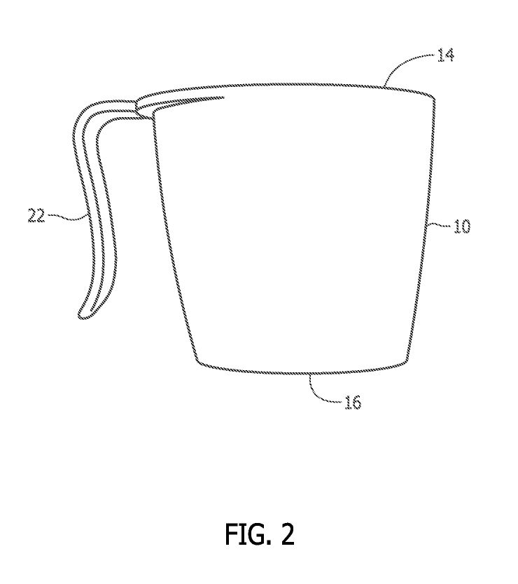

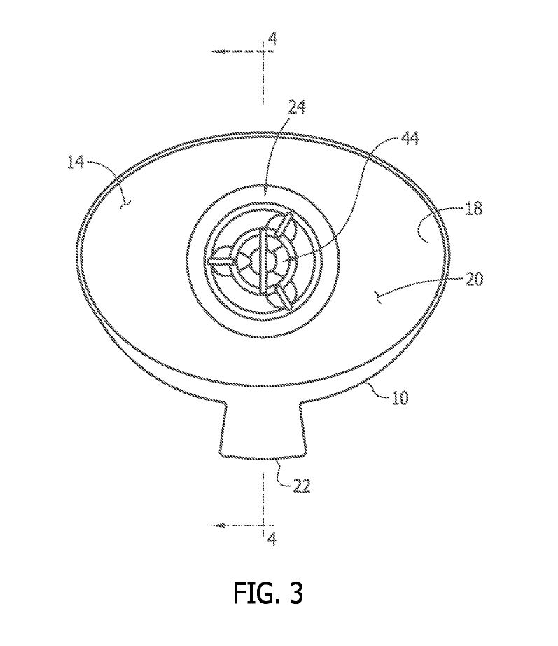

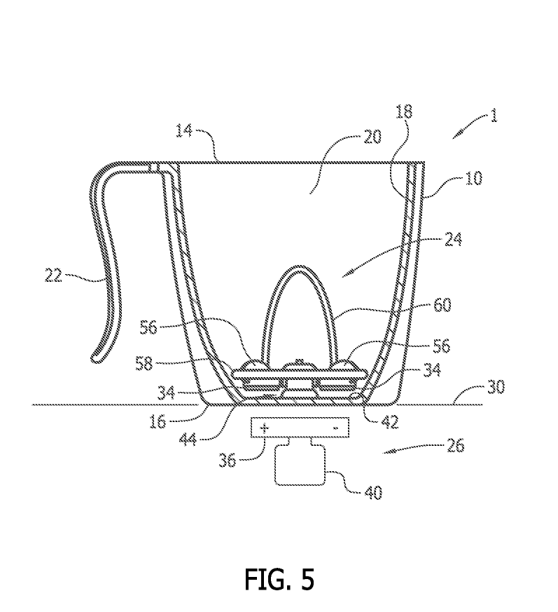

With reference now to FIGS. 1-5, and in particular to FIG. 5, a first embodiment of a mixing system is generally indicated at 1. The illustrated mixing system generally comprises a receptacle 10 into which a powdered beverage and a liquid to be mixed together are loaded, an agitator, generally indicated at 24 (FIGS. 3-5), configured for mixing the contents of the receptacle, and a drive system, generally indicated at 26 (FIG. 5), for driving operation of the agitator. The receptacle 10 illustrated in FIGS. 1-5 is configured as a cup, a bowl or a pitcher, having an open top 14, a closed bottom 16, and an interior surface 18 defining a mixing chamber 20. The illustrated receptacle 10 is particularly configured to facilitate transferring the mixed beverage into another receptacle such as a drinking cup, sports bottle or nursing bottle. For example, to facilitate pouring of the mixed beverage, the top 14 of the receptacle is generally oval-shaped. The receptacle 10 also includes a handle 22. It is understood, however, that the receptacle 10 may be of other suitable configurations without departing from the scope of the present invention. For example, the receptacle 10 may be a different-shaped pitcher, a bowl, a cup, a sports bottle, a nursing bottle, or other suitable receptacle.

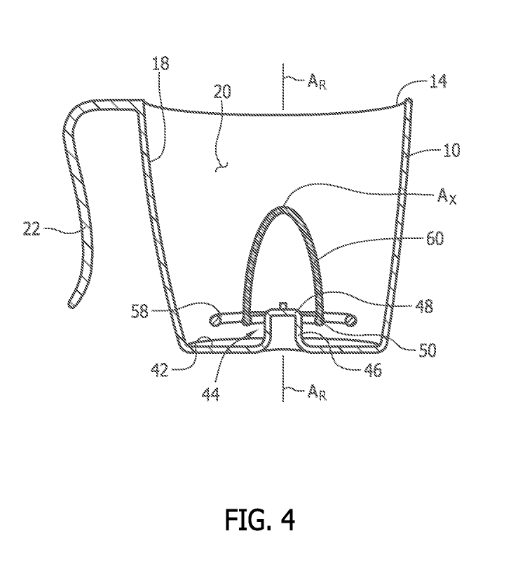

The agitator 24, according to one particularly suitable embodiment, is removably positionable within the mixing chamber 20 of the receptacle 10 and is configured for driven operation thereof to agitate the contents of the receptacle and facilitate mixing of the contents. In the illustrated embodiment, the agitator 24 is a rotary agitator capable of driven rotation on a rotation axis AR (FIG. 4) within the mixing chamber 20 to agitate the contents of the receptacle 10. For example, as illustrated in FIG. 5, the agitator 24 is configured for operative coupling with the drive system 26 disposed exterior of the receptacle such that operation of the drive system imparts rotation to the rotary agitator. As a further example, the drive system 26 may be a component of the dispensing appliance 28 illustrated in FIGS. 12 and 13, with the drive system being disposed generally beneath the platform 32 on which the receptacle 10 is supported. In other embodiments (FIG. 5), the mixing system 1 may comprise a platform 30 or other support on which the receptacle is supported, with the drive system 26 disposed beneath the platform or other receptacle support. Alternatively, the receptacle may be supported other than by a platform or structure on which the bottom of the receptacle seats. Rather, in such an embodiment, the bottom of the receptacle may seat directly on the drive system 26.

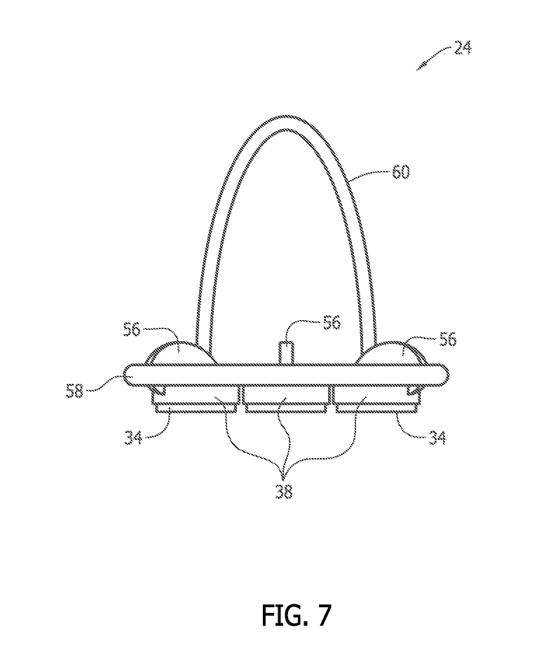

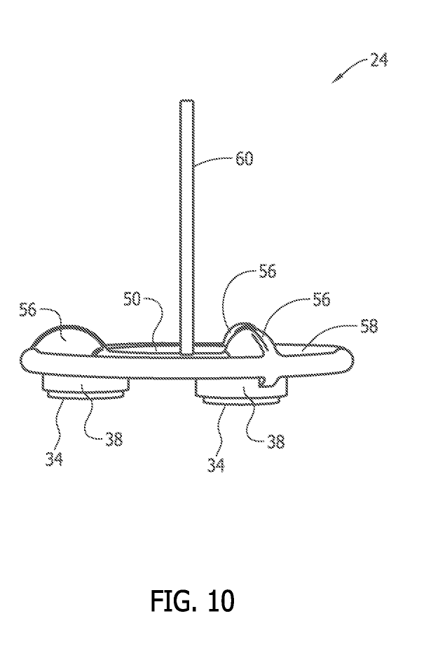

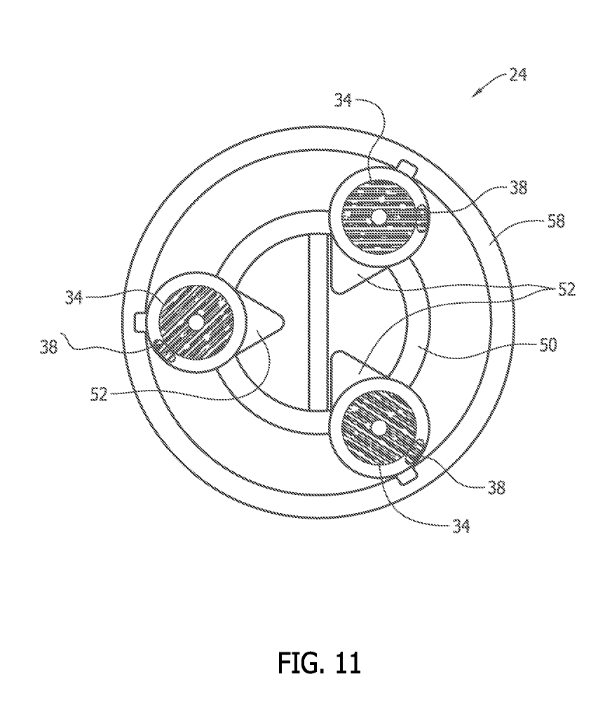

In a more suitable embodiment, the operative coupling between the agitator 24 and the drive system 26 is a magnetic coupling. Referring to FIGS. 5, 7, 8, 10 and 11, in the illustrated embodiment the agitator 24 comprises three magnetic coupling components 34, such as magnets or other material capable of magnetic attraction) retained in magnet housings 38 formed integral with (or formed separate and attached to) the agitator. The magnets 34 are spaced about the rotation axis AR at equal intervals. It is contemplated, however, that any number of magnetic coupling components may be used without departing from the scope of this invention. For example, a single magnetic coupling component extending continuously about the rotation axis AR may be used.

The drive system 26, with reference to FIG. 5, comprises a magnetic drive component 36 (e.g., one or more magnets or material capable of magnetic attraction) that rotates or revolves below the receptacle 10 (e.g., below the platform 32 in the dispensing appliance of FIGS. 12 and 13). A suitable motor 40, such as an electric motor, drives rotation or rotating oscillation of the magnetic driving component 36. As will be understood, the magnetic coupling components 34 magnetically couple the agitator 24 to the magnetic driving component 36 of the drive system by a sufficient magnetic force so that agitator 24 rotates conjointly with the magnetic driving component 36.

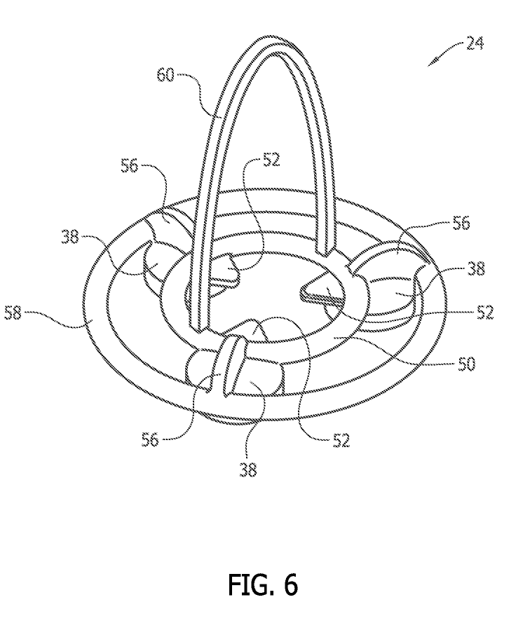

As illustrated in FIGS. 4 and 5, the agitator 24 may be retained within the mixing chamber 20 in spaced relationship above a floor 42 of the mixing chamber. Alternatively, the agitator 24 may rest on or otherwise contact the floor 42 of the mixing chamber 20. In the illustrated embodiment, a suitable retention member, generally indicated at 44, is secured to the bottom of the receptacle 10 and is disposed at least in part within the mixing chamber 20 to removably retain the agitator 24 in the receptacle, such as when the mixed beverage is being poured from the receptacle. The illustrated retention member 44 comprises a stem 46 extending up from the floor 42, with a head 48 formed at the upper end of the stem. The agitator 24 includes a retaining ring 50 that encircles the stem 46 and has a plurality of flexible detents 52 (seen best in FIG. 6) extending radially inward from the retaining ring. The agitator 24 is releasably secured on the retention member 44 by sliding the retaining ring 50 downward over the head 48 of the retention member, whereby the detents 52 elastically deflect as they slide along the head and return to their original configuration when they pass to a position below the head.

The head 48 of the retention member 44 thus inhibits the agitator 24 against falling out of the receptacle 10 when the receptacle is partially or wholly inverted to pour the mixed beverage from the receptacle. In particular, the detents 52 retain the agitator 24 on the retention member 44 while allowing the agitator to rotate relative thereto. In general, the inner diameter defined by the free ends of the detents 52 is greater than a diameter of the stem 46 beneath the head 48 to reduce friction between the detents and the stem when the agitator 24 is rotated. To remove the agitator 24 from the receptacle 10, such as for cleaning, the agitator is simply pulled upward with sufficient force to pull the detents 52 back up over the head 48 of the retention member 44.

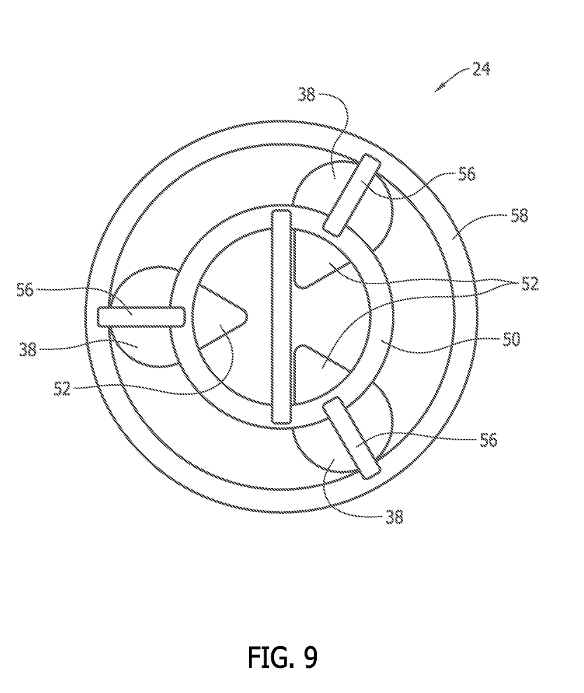

As seen best in FIGS. 6-10, the agitator 24 includes a plurality of blades 56 projecting up from the magnetic component housings 38 and extending radially outward from the retaining ring 50, and an outer support ring 58 extending around and connecting outer ends of the blades. The illustrated agitator 24 includes three blades 56 that are spaced at equal intervals around the retaining ring 50. It is understood, however, that the number of blades may be less than or greater than three and remain within the scope of this invention. When the agitator 24 is rotated within the mixing chamber 20, the blades 56 push against the liquid to produce a swirling flow of liquid. The outer support ring 58 provides additional structural support for the blades 56 and absorbs forces applied on the blades during mixing. In the illustrated embodiment, the support ring 58 is substantially concentric with the retaining ring 50. It is understood, however, that the reinforcement ring 58 may be omitted from the agitator 24 without departing from the scope of the present invention. It is understood that rotation of the agitator 24 may be either clockwise or counter-clockwise. In other embodiments that agitator 24 may be oscillated in rotation, or intermittently rotated for a predetermined period first in one direction and then the opposite direction, without departing from the scope of this invention.

As explained above, the blades 56 of the agitator 24 produce a swirling flow of liquid to facilitate mixing. It has been observed that absent further configuring of the agitator 24 this swirling flow tends to form a funnel-shaped vortex extending downward toward the agitator 24. The funnel-shaped vortex has a center void or open space extending generally along the rotation axis AR and can extend down to the floor 42 of the receptacle 10. It has been further observed that there is inconsistent mixing of the liquid and powder when the funnel-shaped vortex is formed, and in particular, clumps of powder tend to accumulate adjacent to the void of the funnel-shaped vortex. To this end, the illustrated agitator 24 is further configured to have an anti-vortex member 60. The anti-vortex member 60 illustrated in FIG. 6 is generally arch-shaped and lies in substantially a vertical plane that includes the rotation axis AR of the agitator 24.

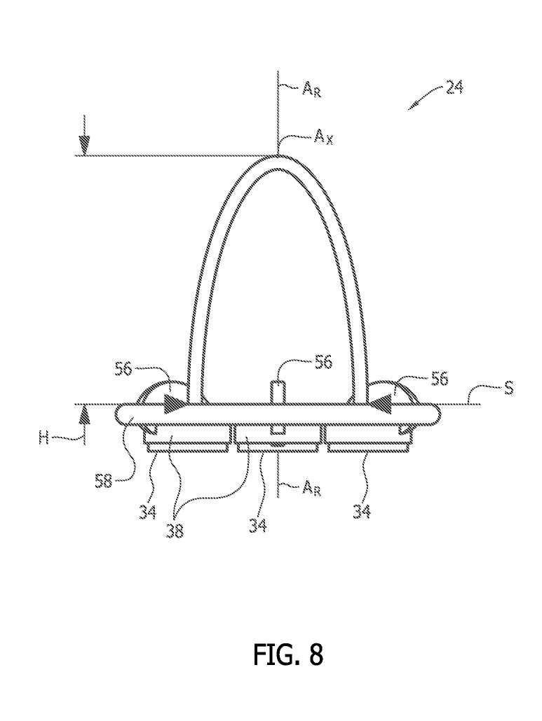

Referring to FIG. 8, the arch-shaped member 60 has opposite, diametrically opposite ends secured to the retaining ring 50, and an apex AX substantially aligned with the rotation axis AR of the agitator 24 (i.e., the rotation axis passes through the apex). The opposite ends are spaced from each other to define a span S lying in a base plane of the agitator 24. A height H of the arch-shaped member 60 extends perpendicularly from the base plane to the apex AX. In one example, the ratio of the span S to the height H of the arch-shaped member 60 may be from about 1 to about 3. It is understood, however, that the anti-vortex member 60 may be other than arch-shaped without departing from the scope of the present invention. It is also understood that the anti-vortex member 60 may include additional structural features without departing from the scope of the present invention. For example, a second arch-shaped member perpendicular to that illustrated in FIG. 6 may be used. It is also understood that the anti-vortex member 60 may be omitted without departing from the scope of this invention.

An entirety of the agitator 24, aside from the magnetic coupling components 34, may be formed from a suitable plastic material that is molded, such as by a suitable injection molding process. The magnetic coupling components 34 can be attached to the molded agitator 24 (e.g., within the housings 38) by adhesive or in other suitable ways. In another embodiment, the magnetic coupling components 34 can be enclosed within or otherwise secured to the agitator 24 by overmolding the agitator about all or part of each magnetic coupling component. In yet another example, the agitator 24 may be formed of a magnetic material that can be magnetized, such as steel or iron, such that the entire agitator or a portion thereof functions as the magnetic coupling component.

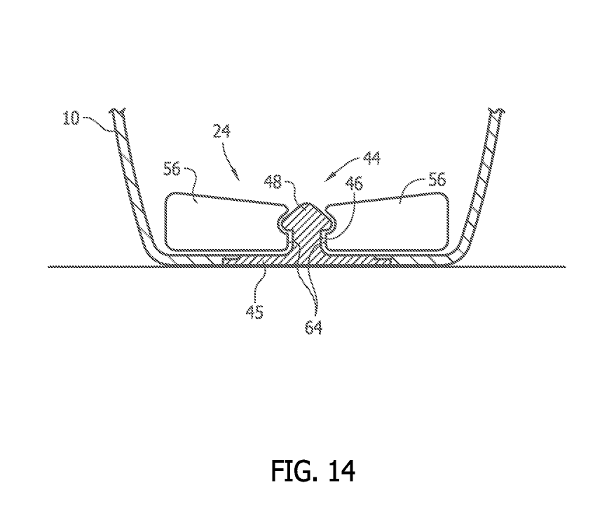

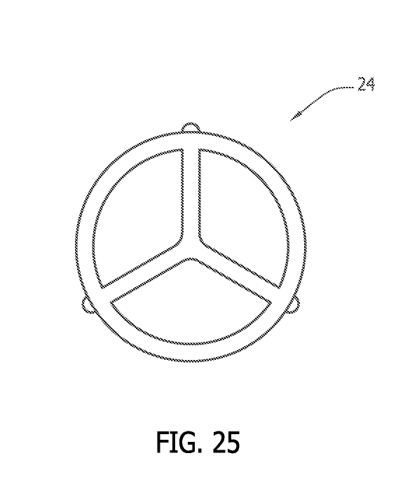

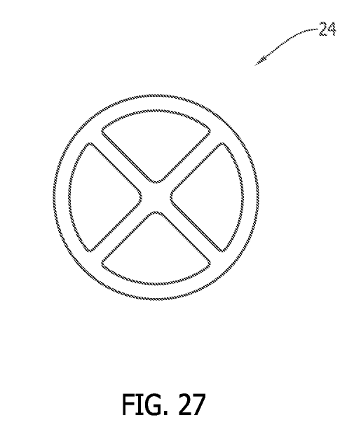

FIGS. 14-31 illustrate other embodiments of a suitable mixing system with a receptacle, agitator and drive system. Similar and like components are indicated by corresponding reference numerals and new components are indicated by new reference numerals.

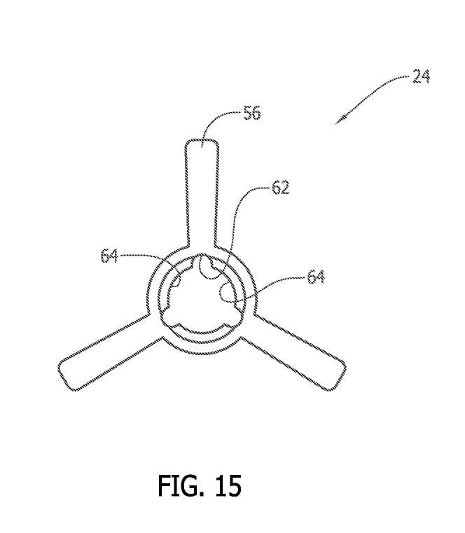

In a second embodiment of the mixing system 1, illustrated in FIG. 14, the receptacle 10 including the retention member 44 are similar to that disclosed in the embodiment of FIGS. 1-11, with the retention member comprising a stem 46 with a head 48. In the present embodiment, the agitator 24 as illustrated in FIG. 15A is in the form of a three-blade 56 impeller with a central hub having a plurality of grooves 62 that circumferentially separate a plurality of elongate, circumferentially extending detents 64. To secure the agitator 24 on the retention member 44, the hub is placed down over the head 48 so that the detents elastically flex to allow the detents to move down past the head where the detents return to their undeflected state. The blades 56 of the impeller each include a magnetic coupling component (not shown). The agitator 24 of this embodiment is suitably magnetically coupled with a drive system, which is not shown but may be substantially similar to the drive system 26 of FIG. 5. Also in this embodiment, the retention member 44 is formed integrally with a bottom plate 45 that is formed separate from and secured to the bottom 16 of the receptacle 10 to in part form the receptacle bottom.

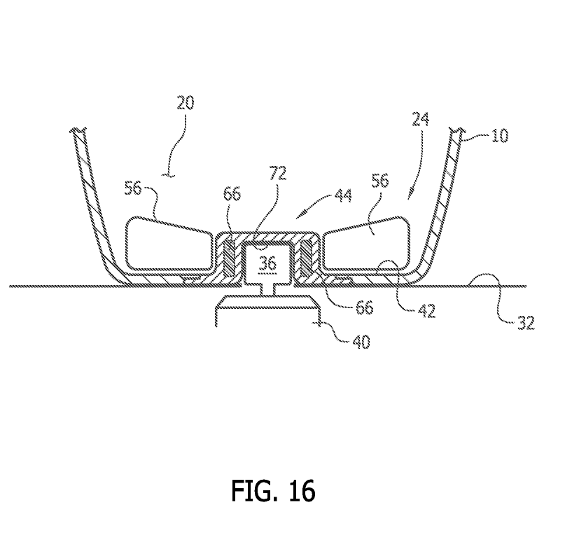

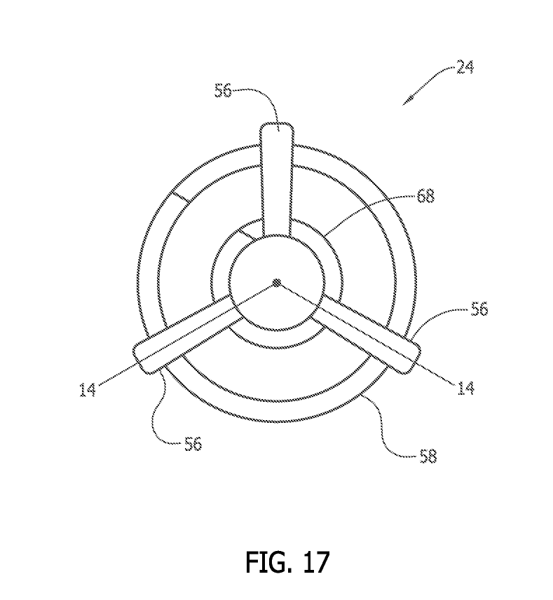

With reference to FIGS. 16 and 17, a third embodiment of the mixing system 1 includes a receptacle 10 in which the bottom 16 of the receptacle is formed to define an inward projecting hub 44 within the mixing chamber 20 and a recess 72 formed in the bottom of the receptacle. The hub 44 partially defines a retention member, which also includes one or more magnetic components 66 disposed within the sidewall of the hub to releasably retain the agitator 24 within the receptacle 10 when the receptacle is inverted to pour out the contents of the receptacle. The agitator 24 of this embodiment includes an outer support ring 58, an inner coupling ring 68 concentric with the outer support ring, and a plurality (e.g., three in the illustrated embodiment) blades 56 extending radially outward from the coupling ring to beyond the outer support ring. The coupling ring 68 and/or the blades 56 suitably include or are otherwise formed of a magnetic coupling component that is magnetically attracted to the magnetic retention components 66. As such, the agitator 24 is retained on the hub 44 by a magnetic retaining force between the agitator and the magnetic retention component 66. In a particularly suitable embodiment, the magnetic retention component 66 provides an attraction force sufficient to retain the agitator 24 in the receptacle 10 when the receptacle is partially or wholly inverted, while still allowing a user to selectively remove the agitator from the receptacle for cleaning and/or other purposes.

The drive system 26 of this embodiment includes a magnetic drive component 36 sized to seat within the recess 72 in the bottom of the receptacle 10. The magnetic drive component 36 is driven in rotation by a suitable motor 40 for rotation about its axis. When the magnetic drive component 36 is received in the drive recess 72, a magnetic coupling force couples the magnetic coupling component 68 of the agitator 24 to the magnetic drive component 36. This magnetic coupling force is suitably greater than the magnetic retaining force between the magnetic retention component 66 and the agitator 24 so that rotation of the agitator by the drive system 26 is uninhibited by the retention member 44. It is alternatively contemplated that the magnetic retention component 66 may be configured for rotation within the retention member 44 to rotate conjointly with the drive component 36 and agitation 24.

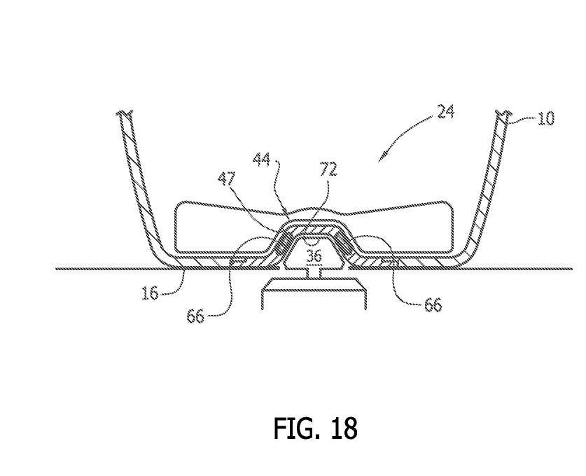

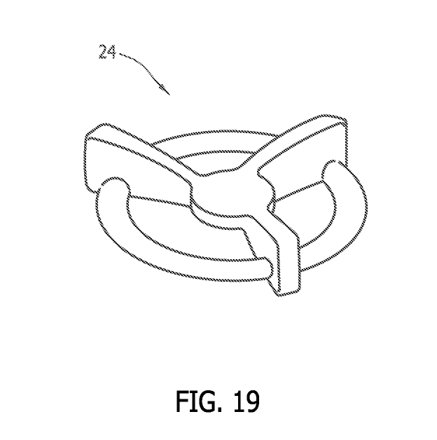

The mixing system 1 of a fourth embodiment, illustrated in FIGS. 18 and 19, is substantially similar to that of the embodiment of FIG. 16. In this embodiment, however, the hub 44 at the bottom 16 of the receptacle 24 is frustoconical (e.g., having an outward tapering sidewall with the magnetic retention components 66 disposed therein). Moreover, instead of a central opening in the agitator 24, the underside of the agitator is configured to define a cavity 47 sized and configured to seat over the hub 44 at the bottom 16 of the receptacle 10. The magnetic drive component 36 is configured to correspond with the configuration of the hub 44, and to seat within the recess 72 in the bottom 16 of the receptacle 10.

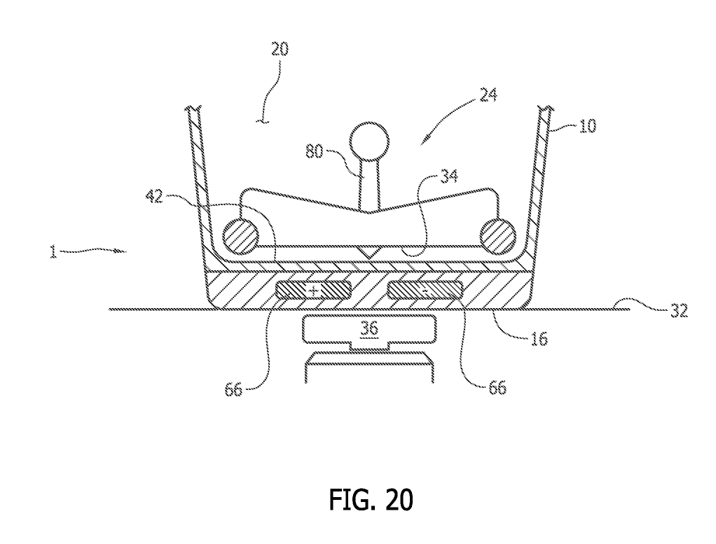

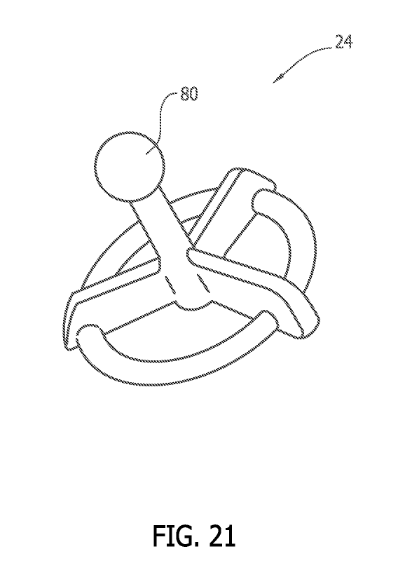

Referring to FIGS. 20 and 21, in a fifth embodiment, the mixing system 1 includes a receptacle 10 in which the bottom 16 of the receptacle is configured with an imbedded retention member 66 (e.g., such as by overmolding or other suitable technique) in the form of one or more magnetic retaining components disposed beneath the floor 42 of the mixing chamber 20. The magnetic retaining component(s) 66 retain the agitator 24 within the receptacle 10 when the receptacle is inverted to pour out the contents of the receptacle. The agitator 24 comprises a magnetic coupling component 34 (e.g., a portion or an entirety of the agitator) that is attracted to the magnetic retaining component(s) 66 by a magnetic retaining force. This embodiment is similar to the first embodiment in that the magnetic drive component 36 of the mixing appliance is located below the mixing chamber 20 (e.g., below the platform 32 on which the receptacle 10 is placed). However, this embodiment is similar to the third and fourth embodiments in that the attractive magnetic coupling force between the magnetic drive component 36 and the magnetic coupling component 34 of the agitator 24 is greater than the magnetic retaining force.

The agitator 24 of this fifth embodiment also includes a handle 80 comprising an upwardly extending post having a nub at its free end. The handle 80 can be gripped by a user to pull the agitator 24 upward with sufficient force to remove the agitator from the receptacle 10. The handle 80 may be of other configurations without departing from the scope of the present invention.

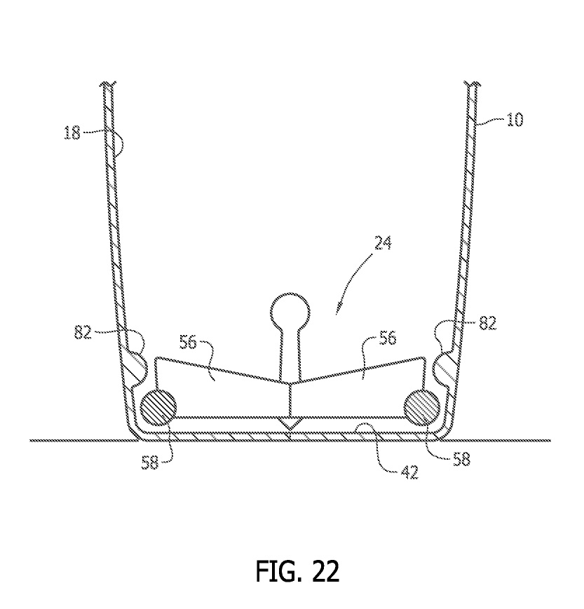

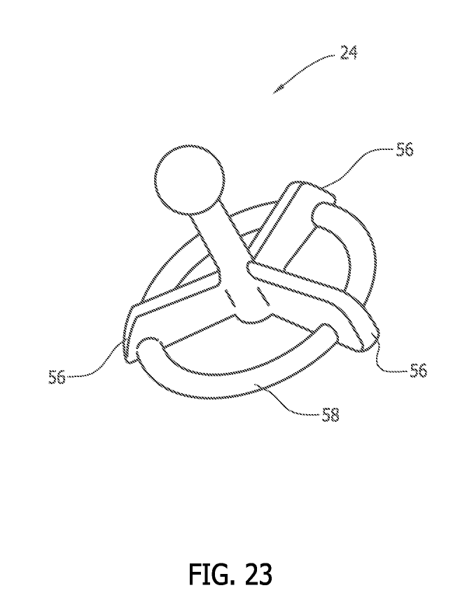

In a sixth embodiment, illustrated in FIGS. 22 and 23, the receptacle 10 includes a retention member in the form of one or more detents 82 projecting transversely inward from the sidewall 18 of the receptacle at a location slightly above the floor 42 of the mixing chamber 20. For example, the retention member may comprise a single continuous detent (e.g., a ring) 82, or two or more discrete detents space circumferentially from each other on the sidewall 18 of the receptacle 10. The detent(s) 82 is suitably elastically deformable (e.g., elastically compressible) and may be generally annular or may comprise a plurality of members extending around the interior surface of the sidewall 18. The agitator 24 of this embodiment is configured to include at least one interference member 58 with the agitator sufficiently sized such that the interference member is transversely positioned outward of the innermost extent of the retention member (i.e., the one or more detents 82). As an example, the interference member may comprise a ring 58 circumscribing the plurality of blades 56, or a discrete interference member may be disposed at the free end of each of the blades.

In use, when the receptacle 10 is turned over to pour out the contents thereof, the agitator 24 starts to slide outward of the receptacle until the interference member(s) 58 contact the detent(s) 82 wherein the detents inhibit the agitator from falling out of the receptacle. However, the agitator 24 may be manually removed from the receptacle 10, such as for cleaning, by pulling the agitator out of the receptacle with sufficient force to elastically deform the detent(s) 82 to allow the agitator to pass outward of the retention member. Alternatively, or additionally, the interference member(s) may be elastically deformable.

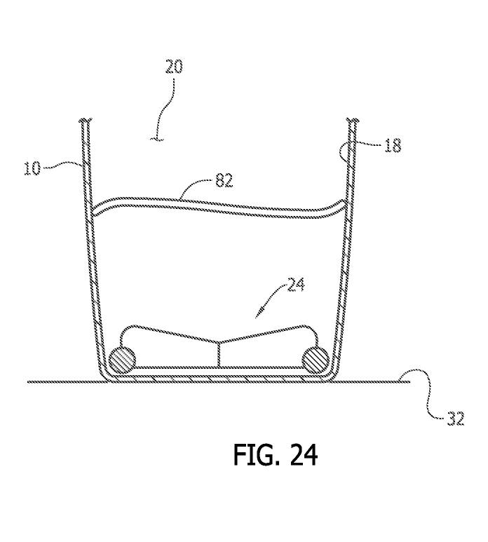

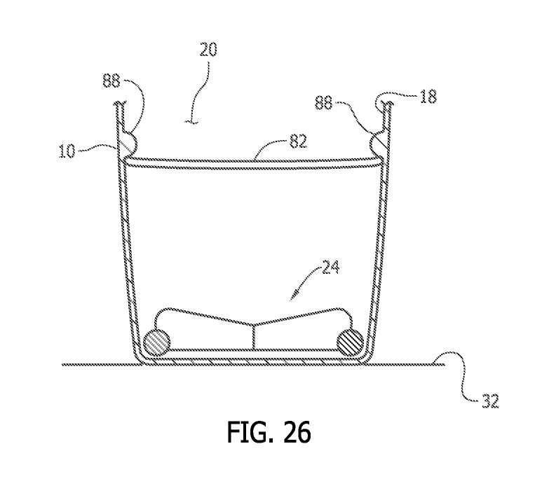

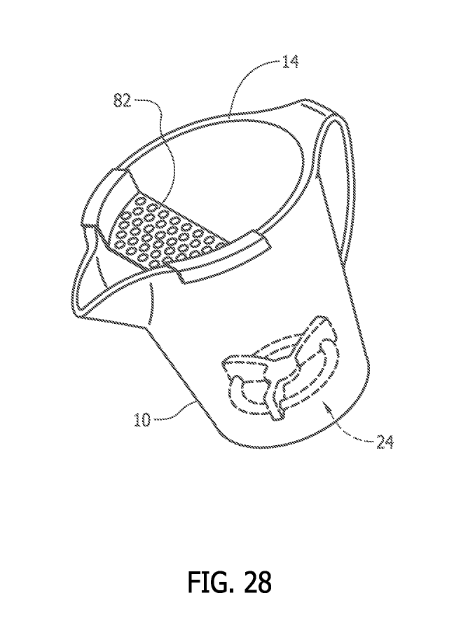

Referring now to FIGS. 24-28, in seventh, eighth and ninth embodiments similar to the embodiment of FIGS. 22 and 23, the receptacle 10 includes a retention member in the form of a screen, or sieve 82 releasably secured to the receptacle to removably retain the agitator 24 in the mixing chamber 20. The sieve 82 may be a mesh screen or another structure including openings for allowing the mixed contents of the receptacle 10 to pass therethrough while inhibiting the agitator 24 against falling out of the receptacle. In the seventh embodiment, illustrated in FIG. 24, the sieve 82 may be press fit against the inner surface of the sidewall 18 of the receptacle 10 within the mixing chamber 20. In FIG. 26 (the eighth embodiment), the sieve 82 is removably secured within the receptacle by a suitable a detent 88 (or detents). In FIG. 28 (the ninth embodiment), the sieve 82 may be removably secured to the top 14 of the receptacle 10. In this embodiment the sieve 82 covers only a portion of the open top 14 of the receptacle 10. However, the sieve 82 may cover the entire open top 14 of the receptacle and remain within the scope of this invention.

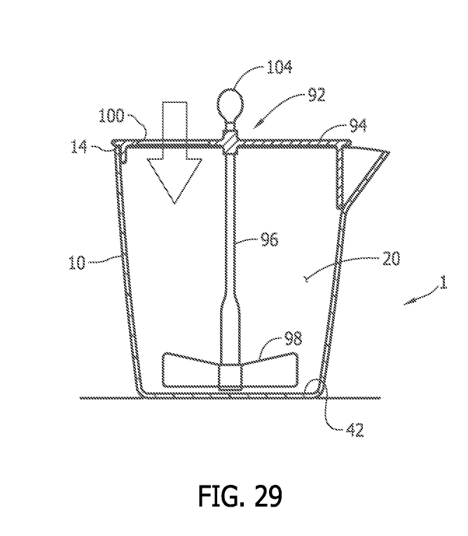

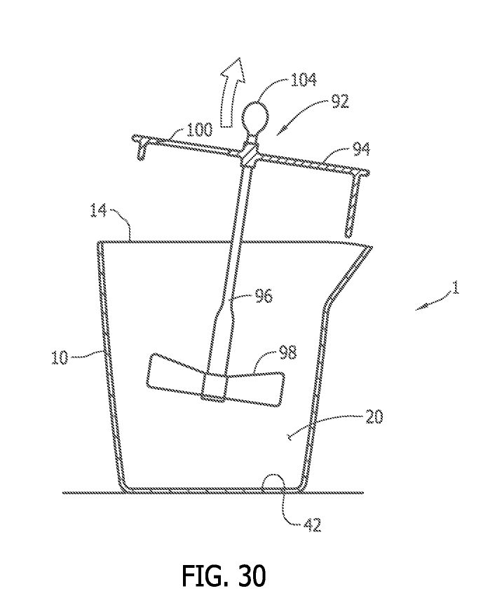

With reference to FIGS. 29 and 30, a tenth embodiment of the mixing system 1 includes an agitator assembly, generally indicated at 92, comprising a lid 94, a post 96 secured to the lid and depending therefrom to adjacent the bottom of the receptacle, and an agitator 98 rotatably mounted on the post adjacent the bottom of the receptacle. The lid 94 is removably secured to the top 14 of the receptacle 10, such as by a press-fit, snap-fit or other suitable connection. The lid 94 has an opening 100 through which powdered beverage and liquid can be loaded into the receptacle 10. The agitator 98 is disposed slightly above the floor 42 of the mixing chamber 20 when the lid 94 is secured to the receptacle 10. The agitator 98 is suitably magnetically coupled to a drive system (not shown) in any of the manners described previously for driven rotation of the agitator. Alternatively, the post 96 may be configured for conjoint rotation with the agitator relative to the lid 94. After mixing is completed, the entire agitator assembly 92 can be removed by pulling upward on a handle 104 of the assembly.

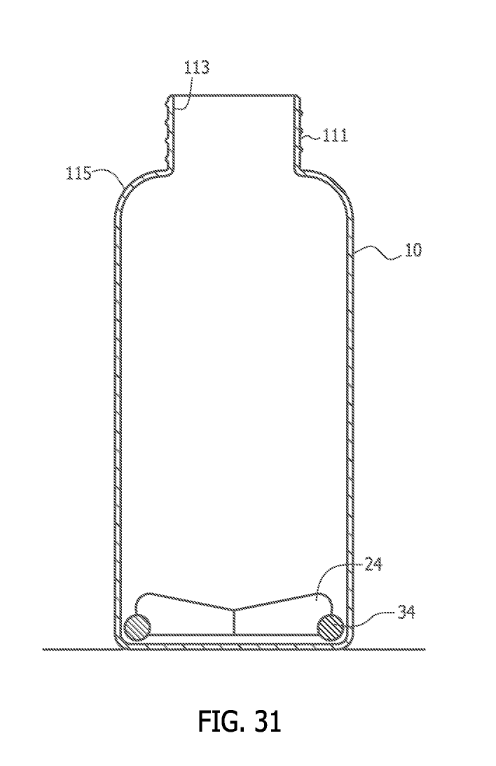

With reference to FIG. 31, in an eleventh embodiment of the mixing system a retention member may be formed integrally with the receptacle. For example, in the illustrated embodiment the receptacle 10 is in the form of an infant nursing bottle, and includes a neck 111 leading to the open end 113 of the bottle, and a shoulder 115 that tapers inward from the main body of the bottle to the neck thereof. An agitator 24, which in the illustrated embodiment is generally identical to the agitator of FIG. 24 but may be in the form of any of the agitators disclosed in the various embodiments herein, is suitably sized larger than the bottle opening such that the shoulder 115 and neck 111 together broadly define a retention member to inhibit the agitator against falling out of the bottle or otherwise into the nipple during use. For example, in one suitable embodiment where the neck 111 of the bottle has an inner diameter of about 32 mm, the agitator 24 may have a transverse cross-sectional dimension (e.g., outer diameter in the illustrated embodiment) in the range of about 34 mm to about 45 mm.

The agitator 24 is suitably constructed from a sufficiently flexible and resilient material, such as for example, silicone rubber, polypropylene or other suitable material, to allow deformation of the agitator for inserting the agitator into or removing the agitator from the bottle. To facilitate additional flexibility, the magnetic coupling components 34 may be disposed more centrally of the agitator 24. In this manner, the user could, if necessary, even trim the outermost extent of the agitator to better accommodate the inner diameter of the main body of the bottle (i.e., in which the agitator rotates.

It is also understood that in any of the above embodiments as well as alternative embodiments a retention member may be omitted, so as to permit the agitator to be readily dropped or placed into and freely removed from the receptacle. It is also understood that while in the various embodiments disclosed herein the agitator is a combination of a support member and the magnetic coupling components, the agitator may be comprised solely of a magnetic coupling component and remain within the scope of this invention. It is also understood that such a magnetic coupling component may be of any suitable configuration and/or shape. It is further contemplated that instead of rotating on an axis, the agitator and drive system may be configured for orbital or eccentric movement within the receptacle to facilitate mixing.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

What is claimed is:

1. A mixing system for mixing together a powdered beverage and a liquid in-situ to form a ready-to-drink beverage, the mixing system comprising:
a receptacle having an interior space defining a mixing chamber for receiving powdered beverage and liquid therein to be mixed;
an agitator removably disposed in the mixing chamber, the agitator being operable for movement relative to the receptacle to mix the powdered beverage and liquid within the mixing chamber, said agitator being removable from the receptacle;
a retention member configured to inhibit the agitator against falling out of the receptacle upon substantially inverting the receptacle, said retention member being further configured to allow operation of the agitator to mix the powdered beverage and liquid within the mixing chamber; and
a drive system for operating the agitator, the agitator and drive system being configured for operative non-contact coupling therebetween.

2. The mixing system of claim 1 wherein the agitator is operable for rotation thereof within the mixing chamber to mix the powdered beverage and liquid within the mixing chamber, the drive system being operable to drive rotation of the agitator.

3. The mixing system of claim 1 wherein the agitator includes a magnetic coupling component and the retention member includes a magnetic retention component such that an attractive magnetic retaining force between the magnetic coupling component and the magnetic retention component inhibits the agitator against falling out of the receptacle upon substantially inverting the receptacle.

4. The mixing system of claim 3 wherein the retention member includes a hub disposed in the mixing chamber, at least a portion of the agitator surrounding the hub, the magnetic retention component being disposed at least one of on and within the hub.

5. The mixing system of claim 4 wherein the hub is generally cylindrical.

6. The mixing system of claim 4 wherein the hub is generally frustoconical.

7. The mixing system of claim 1 wherein the drive system includes a magnetic drive component, an attractive magnetic coupling force between the magnetic coupling component of the agitator and the magnetic drive component of the drive system operatively couples the agitator and the drive system.

8. The mixing system of claim 7 wherein the receptacle has a bottom configured to define a hub extending up from the bottom into the mixing chamber and a recess extending into the bottom of the receptacle, the agitator at least in part surrounding said hub, the magnetic drive component of the drive system at least in part being receivable in the recess in the bottom of the receptacle.

9. The mixing system of claim 1 wherein the retention member is removable from the receptacle.

10. The mixing system of claim 1 wherein the receptacle has a top, the retention member comprising a detent disposed within the mixing chamber intermediate the agitator and the top of the receptacle, the agitator and the detent being sized and configured relative to each other such that the detent inhibits the agitator against movement outward past the detent upon substantially inverting the receptacle.

11. The mixing system of claim 10 wherein the retention member further comprises a sieve supported by the detent within the mixing chamber and spanning the mixing chamber to block the agitator from movement outward past the sieve while allowing liquid within the mixing chamber to pass therethrough.

12. The mixing system of claim 1 wherein the receptacle has a bottom and the retention member includes a stem extending up from the bottom into the mixing chamber, the stem having a head thereon in spaced relationship with the bottom of the receptacle, the agitator being configured to at least in part surround the hub, the agitator comprising a detent sized for interference with the head of the stem such that the head of the stem inhibits the agitator against movement outward past the head of the stem upon substantially inverting the receptacle.

13. The mixing system of claim 1 wherein the retention member is formed integrally with the receptacle.

14. The mixing system of claim 13 wherein the agitator resiliently deformable to facilitate insertion of the agitator into the receptacle past the retention member.

15. The mixing system of claim 1 wherein the agitator includes an arch-shaped anti-vortex member.

16. The mixing system of claim 1 wherein the receptacle is a nursing bottle.

17. The mixing system of claim 1 wherein the receptacle has an open top wherein the opening at the top of the receptacle is generally oval-shaped.

18. The mixing system of claim 1 wherein the agitator includes an upwardly projecting handle to facilitate removal of the agitator from the receptacle.

19. An appliance for mixing together a powdered beverage and a liquid to form a ready-to-drink beverage, the appliance comprising:
a receptacle having an interior space defining a mixing chamber for receiving powdered beverage and liquid therein to be mixed;
a support for supporting the receptacle at least in part in an upright orientation, the receptacle being removable from the support;
an agitator removably disposed in the mixing chamber, the agitator being operable for movement relative to the receptacle to mix the powdered beverage and liquid within the mixing chamber, said agitator being removable from the receptacle; and
a drive system for operating the agitator, the agitator and drive system being configured for operative coupling therebetween.

20. The appliance of claim 19 further comprising a retention member configured to inhibit the agitator against falling out of the receptacle upon substantially inverting the receptacle, said retention member being further configured to allow operation of the agitator to mix the powdered beverage and liquid within the mixing chamber.

21. The appliance of claim 19 wherein the support comprises a seat, the receptacle having a bottom configured to rest on the seat with the receptacle at least in part in an upright orientation, the drive system being disposed at least in part beneath the support seat.

22. The appliance of claim 21 wherein the drive system is disposed entirely beneath the support seat.

23. The appliance of claim 19 wherein the agitator is operable for rotation thereof within the mixing chamber to mix the powdered beverage and liquid within the mixing chamber, the drive system being operable to drive rotation of the agitator.

24. The appliance of claim 20 wherein the agitator includes a magnetic coupling component and the retention member includes a magnetic retaining component such that an attractive magnetic retaining force between the magnetic coupling component and the magnetic retaining component inhibits the agitator against falling out of the receptacle upon substantially inverting the receptacle.

25. The appliance of claim 24 wherein the retention member includes a hub disposed in the mixing chamber, at least a portion of the agitator surrounding the hub, the magnetic retention component being disposed at least one of on and within the hub.

26. The appliance of claim 24 wherein the drive system includes a magnetic drive component, an attractive magnetic retaining force between the magnetic coupling component of the agitator and the magnetic drive component of the drive system operatively coupling the agitator and the drive system.

27. The appliance of claim 24 wherein the receptacle has a bottom configured to define a hub extending up from the bottom into the mixing chamber and a recess extending into the bottom of the receptacle, the agitator at least in part surrounding said hub, the magnetic drive component of the drive system at least in part extending up through the support and being receivable in the recess in the bottom of the receptacle.

28. The appliance of claim 20 wherein the retention member is removable from the receptacle.

29. The appliance of claim 19 wherein the receptacle is a nursing bottle.

30. The appliance of claim 19 wherein the receptacle has an open top wherein the opening at the top of the receptacle is generally oval-shaped.

31. The appliance of claim 19 wherein the agitator includes an upwardly projecting handle to facilitate removal of the agitator from the receptacle.

32. The appliance of claim 19 further comprising a dispensing system for dispensing powdered beverage and liquid into the receptacle while the receptacle is supported by the support.

33. A mixing system for mixing together a powdered beverage and a liquid in-situ to form a ready-to-drink beverage, the mixing system comprising:
a receptacle having an interior space defining a mixing chamber for receiving powdered beverage and liquid therein to be mixed;
an agitator removably disposed in the mixing chamber, the agitator being operable for rotation about a rotation axis of the agitator in a generally horizontal plane to mix the powdered beverage and liquid within the mixing chamber, the agitator including an anti-vortex member extending generally vertically relative to said horizontal plane, the anti-vortex member being rotatable conjointly with the agitating member to inhibit the formation of a vortex about the rotation axis of the agitator; and
a drive system for operating the agitator, the agitator and drive system being configured for operative coupling therebetween.

34. The mixing system of claim 33 wherein the agitator comprises a hub having a plurality of blades extending generally radially outward therefrom, the anti-vortex member extending upward from the body and lying substantially in a plane defined by the rotation axis.

35. The mixing system of claim 34 wherein the anti-vortex member is generally arch-shaped.

36. The mixing system of claim 35 wherein the anti-vortex member has opposite ends secured to the hub and an apex substantially aligned with the rotation axis of the agitator.

37. The mixing system of claim 36 wherein the anti-vortex member has a span extending between the opposite ends and lying in a base plane, and a height extending perpendicularly from the base plane to the apex, wherein the ratio of the span to the height is within a range of about 1 to about 3.
